(19) United States
(12) Patent Application Publication
(10) Pub. No.: US 2004/0104289 A1
(43) Pub. Date: Jun. 3, 2004

(54) File shredder

(76) Inventor: Hermann Schwelling, Salem (DE)

Correspondence Address: Edward R. Freedman, 1077 Northern Blvd., Roslyn, NY, 11576, US

(21) Appl. No.: 10/359,481

(22) Filed: Feb. 6, 2003

(30) Foreign Application Priority Data
Feb. 6, 2002 (DE) 102 05 688.9

(51) Int. Cl. B02C 18/16

(52) U.S. Cl. 241/236

(57) ABSTRACT

The invention relates to a file shredder that comprises at least one cutting mechanism, as well as means for driving and controlling the cutting mechanism. The cutting mechanism has at least two cutting rolls, i.e. working rolls, which each are provided with cutting disks or cutting blades that engage one another, and which have strippers associated with them. In the present case, provision is made for two cutting mechanisms, whereby the outlet for the cut material crushed by the top cutting mechanism serves at the same time as the inlet for the cut material entering the bottom cutting mechanism that is arranged underneath the top cutting mechanism.

The invention relates to a file shredder with a large type of construction that is used for shredding large quantities and also of materials with large volumes carrying data such as stacks of paper, cardboard materials, file holders, bundles of files and the like materials.

So-called heavy-duty file shredders are known in the prior art, in which the material that has to be shredded is squeeze through relatively dull cutting tolls and large cutting gaps and is torn to pieces in this process and not cut into small pieces. An important drawback afflicting this known paper shredding devices is their relatively low degree of efficiency.

Therefore, the problem of the invention consists in providing a paper shredder by means of which it is possible to crush large formatted and/or large-volume data carrier materials with a high degree of efficiency. I.e. with an hourly shredding capacity of more than 2,000 kg, whereby the crushed material at least corresponds with security stage 3.

The problem specified above is solved with the help of a file shredder with the features of claim 1. The dependent claims 2 to 18 disclose advanced embodiments and beneficial embodiment variations of the novel file shredder.

On the one hand, the core of the invention lies in that provision is made for at least two crushing units (cutting mechanisms) that are arranged one on top of the other, whereby at least the top crushing unit comprises two pairs of working rolls that are mounted one on top of the other. Specifically, provision is made in this connection that the top paid of working rolls are feed rolls, and the bottom pair of working rolls are cutting rolls. According to a further special embodiment, provision is made that the bottom pair of working rolls, i.e. the cutting rolls arranged parallel with each other, are arranged in such a manner that the cutting disks of these working rolls mate at least in sections. The working rolls of the top pair of rolls do not mate with each other and are arranged in such a manner that the imaginary outer peripheral line of each feed blade of these feed rolls is positioned with a small spacing from the imaginary peripheral line of the peripheral surface of the cutting disks of the respective associated cutting roll, said peripheral surface being interrupted in sections.

Other design features consist in that the cutting rolls are made from a piece of massive (or solid) steel, i.e. these rolls are robust with bending rigidity. Said cutting rolls are preferably produced from non-wearing chromium-nickel steel, whereby the cutting edges of the cutting disks of these cutting rolls are hardened. Furthermore, the cutting disks of these cutting rolls are provided with a special geometry that is described in greater detail in the following parts of the specification.

Of further substantial significance for the efficiency of the present file shredder is the fact that in the crushing units of the file shredder, which are equipped with four working rolls, a common stripper is associated with the working rolls that are substantially mounted one on top of the other, thus per each cutting roll and feed roll. The stripper may consist of one single piece or it may be assembled from individual components. The prong-like protrusions of the strippers engage the intermediate spaces between the cutting disks of the cutting roll, or the intermediate spaces between the feed blades of the feed roll, and preferably engage the respective core diameter of the working rolls in the form of a half-shell. According to another special embodiment, provision is made that the end areas of the stripper prongs resting against the respective core diameter are realized in the form of an acute angle. The through-extending strippers, which are arranged on the left-hand and right-hand sides of the top cutting mechanism, simultaneously serve for cleaning the intake roll and the cutting rolls. Owing to the fact that a common stripper/stripper comb is associated with each of the right-hand bottom and the right-hand top working roll, as well as with the left-hand bottom and the left-hand top working roll of the cutting mechanism, the cut material is prevented from being repeatedly pulled through the crushing mechanism. Another factor diminishing the capacity of the stripper has been eliminated in this way.

The arrangement of the mating cutting rolls and of the feed rolls disposed laterally above the cutting rolls is configured in such a manner that an intake funnel opening upwards in the form of a “V” is formed in the respective cutting mechanism itself.

The effect of the feed rolls is that the material to be crushed sliding toward the cutting rolls is kept in motion, so that no bridges are formed along the feed line of the material to be crushed. Any such bridge of the material would at least temporarily interfere with the automatic, continual feed of the material to be crushed toward the cutting rolls, which would have a negative influence on the degree of efficiency of a file shredder and therefore counteract the problem posed.

Another feature of the embodiment consists in that a drive is associated with both the left- and the right-hand working rolls of the cutting mechanism. The drive is preferably realized in the form of a chain drive, by which the respective cutting roll is directly driven. Each drive is arranged on the housing in an flexible manner by means of a pivot-mounted bearing plate. Each of the feed rolls is driven via an additional chain drive from the associated cutting roll.

The invention is explained in greater detail in the following with the help of an exemplified embodiment that is schematically shown in the drawings, in which:

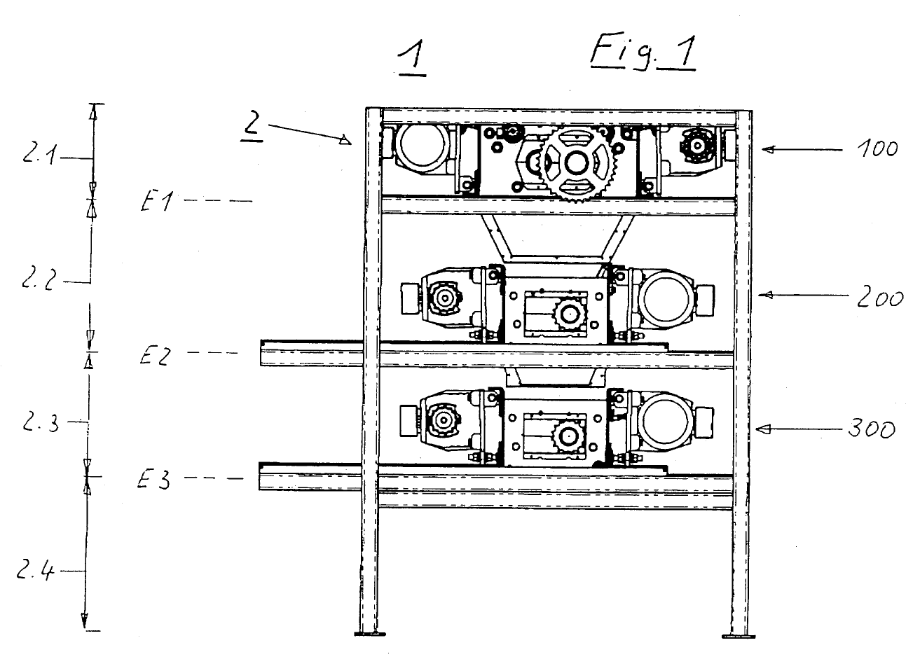

FIG. 1 is a side view of the novel file shredder, in which the covering parts of the housing are removed.

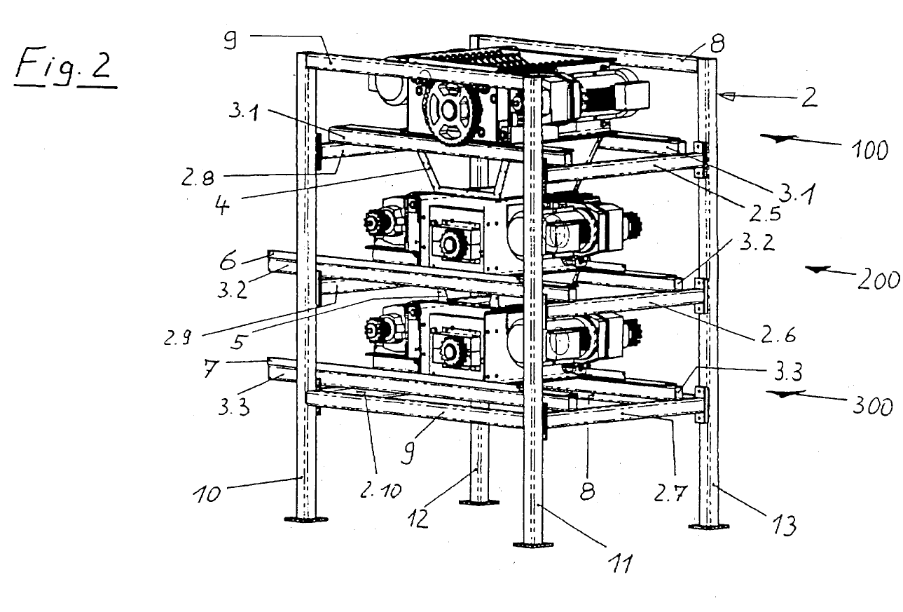

FIG. 2 is a perspective view of the representation according to FIG. 1.

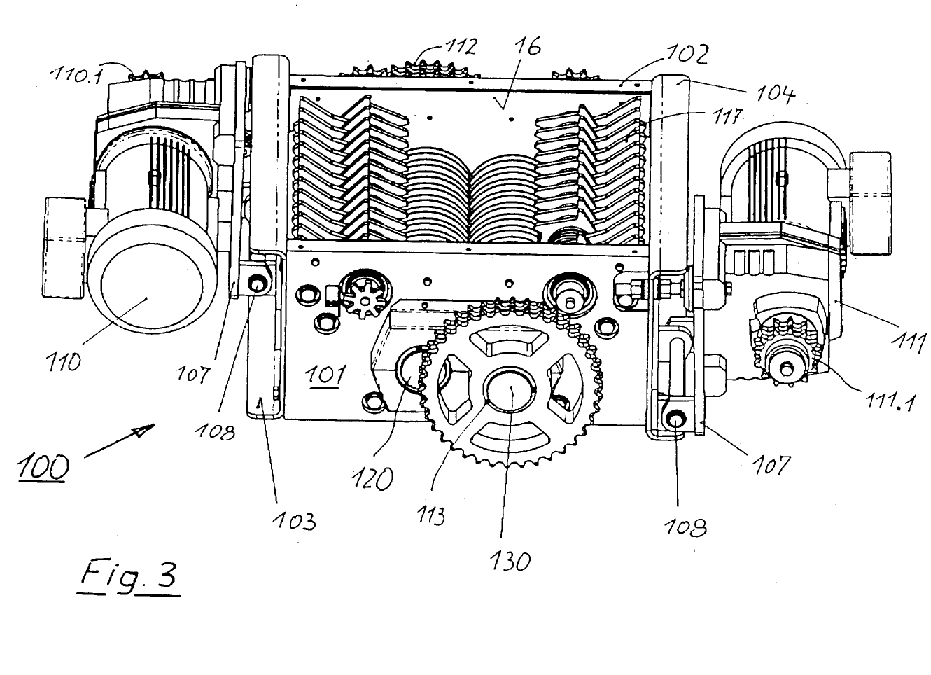

FIG. 3 is a perspective view from the top into a novel cutting mechanism of the file shredder according to FIG. 1.

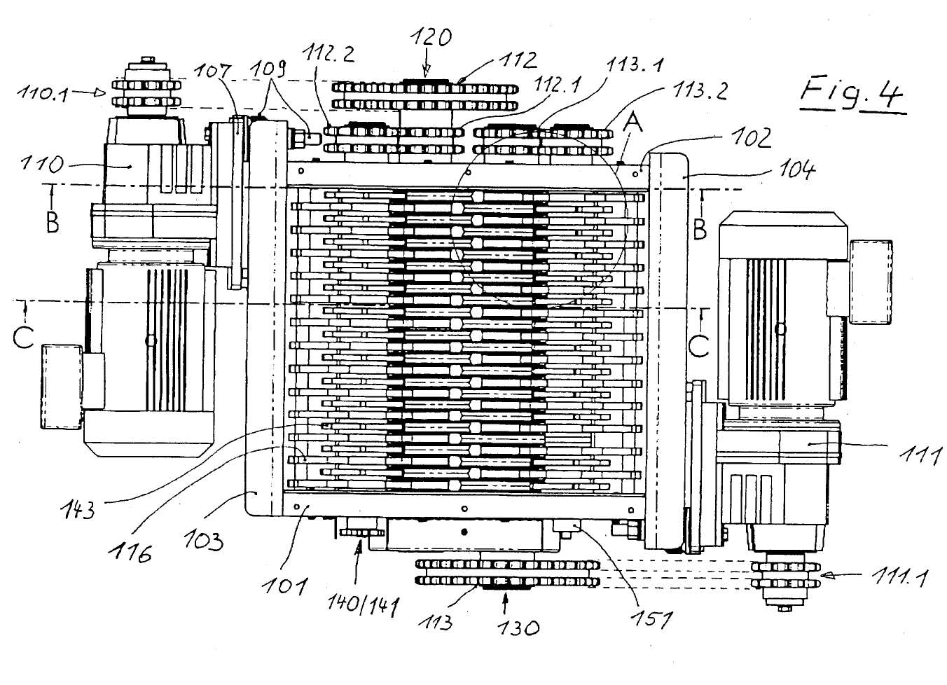

FIG. 4 is a top view of the representation according to FIG. 3.

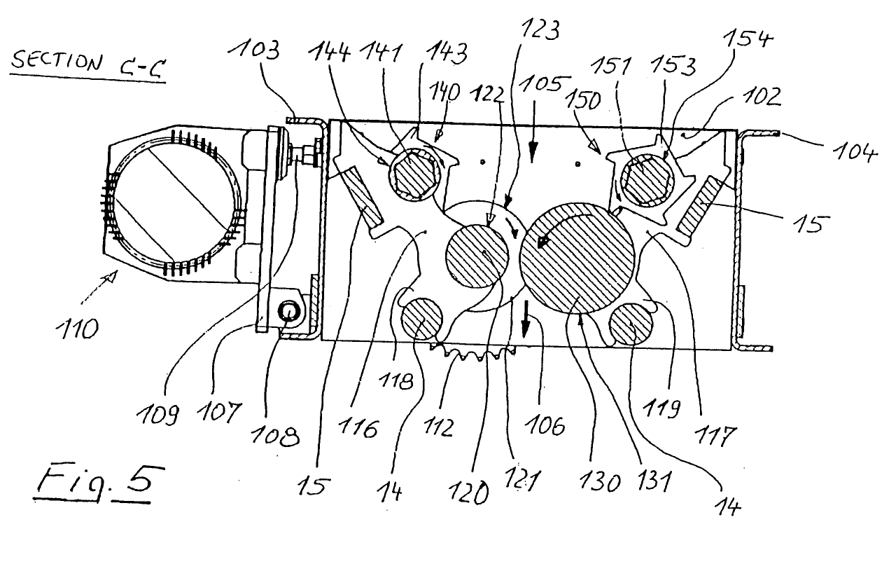

FIG. 5 is a side view of the novel cutting mechanism and of a partial section along line C-C in FIG. 4.

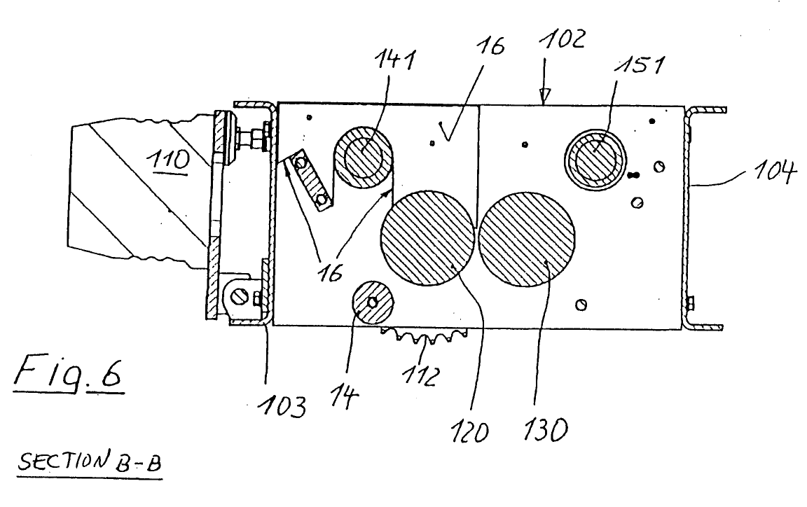

FIG. 6 is a side view of the novel cutting mechanism and of a partial section along line B-B in FIG. 4.

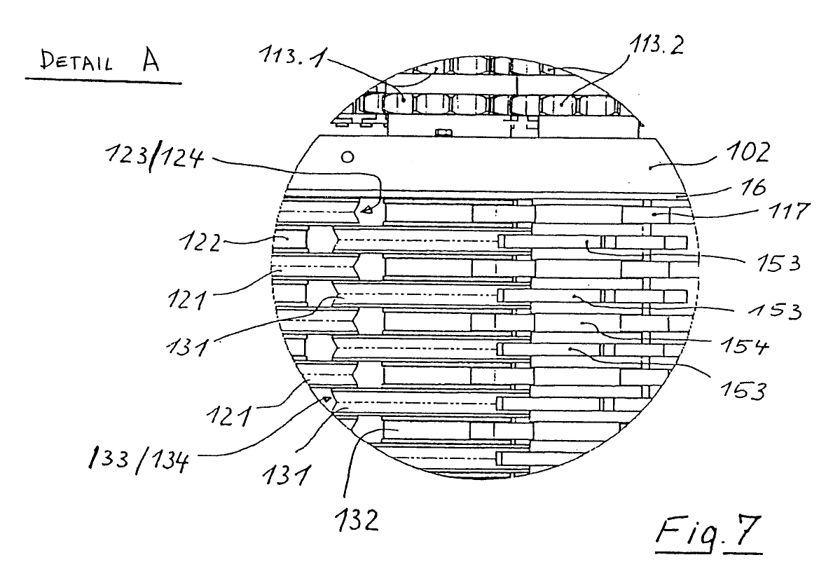

FIG. 7 shows the detail “A” from FIG. 4; and

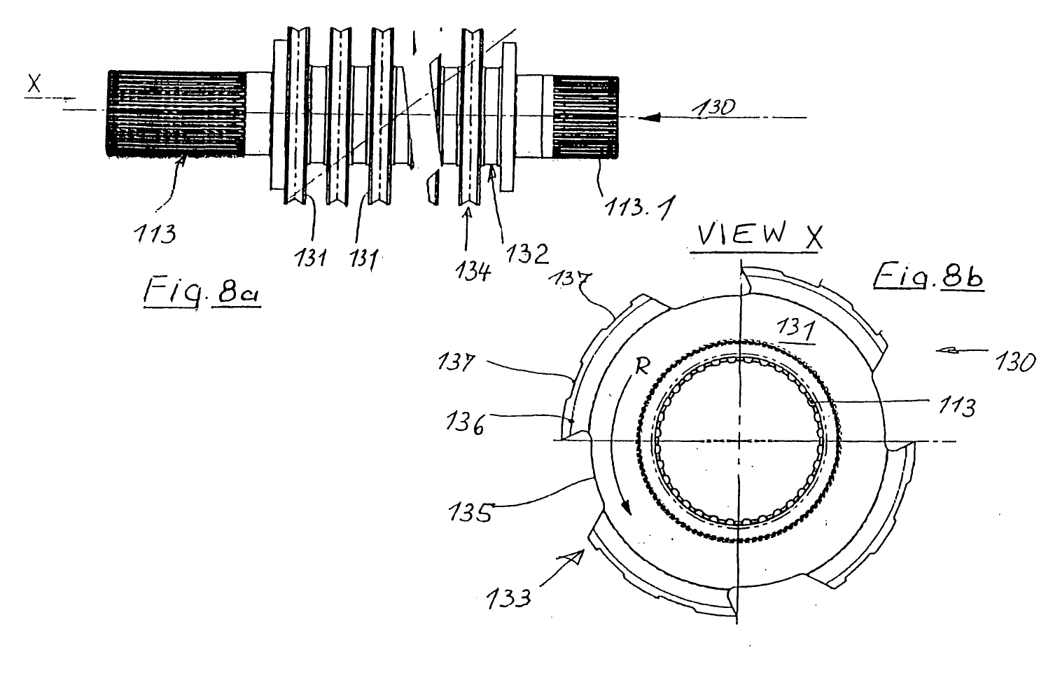

FIGS. 8a and 8b are detailed views of a cutting roll of the novel cutting mechanism.

FIGS. 1 and 2 shows the novel file shredder by a side view and a perspective view, respectively, whereby the parts covering the file shredder 1 have been removed.

The exemplified embodiment of the novel file shredder shown in FIGS. 1 and 2 is comprised of a first cutting mechanism 100, a second cutting mechanism 200, and a third cutting mechanism 300. These cutting mechanisms are successively arranged in the sequence of their enumeration from the top downward in a rack 2. The rack 2 is comprised of the four corner posts 10, 11, 12 and 13, which are connected by means of the longitudinal bridges 9 and 8, as well as by the transverse bridges 2.5 to 2.10, forming a framework.

Bars that are spaced from one another are arranged in pairs on the transverse bridges 2.5 and 2.8; 2.6 and 2.9; and 2.7 and 2.10. These bars connect the transverse bridges with each other and each are forming a guide, namely the upper guide 3.1, the second guide 3.2 and the third guide 3.3. According to this embodiment, the exemplified embodiment described above is thought to be subdivided into an upper area 2.1, a second area 2.2, a third area 2.3, and a lower area 2.4. The planes in which each of these guides 3.1 to 3.3 are disposed are forming the horizontally extending planes E1, E2 and E3, respectively, whereby said planes each are disposed in the boundary region between two neighboring areas.

In the present embodiment, provision is made for the longitudinally displaceable skids 6 and 7 at least in the second guide 3.2 and the third guide 3.3, respectively. These skids may be a component of the guides or a component of the housing of the respective cutting mechanism 200 and 300, respectively. The present embodiment offers the benefit that depending on the shredding task on hand, i.e. the type of starting material that has to be crushed, at least the second cutting mechanism 200 and the third cutting mechanism 300 can be selectively replaced by a cutting mechanism with another capacity, or removed.

The area of transition between the outlet opening 106 of the first cutting mechanism 100, and the inlet opening of the second cutting mechanism 200 disposed on top of the former, and the outlet opening of the second cutting mechanism 200 arranged at the bottom and the inlet opening of the third cutting mechanism 300 disposed on top, is bridged by a first hopper 4 and a second hopper 5, respectively, and bulwarked against the environment, so that crushed material cannot readily drop from the file shredder sideways.

The cutting outputs of the first cutting mechanism 100, the second cutting mechanism 200 and the third cutting mechanism 300 are coordinated with each other in such a manner that the cutting mechanism arranged at the bottom will not run idle, on the one hand, and that the feed area that is formed in the respective cutting mechanism by the respective hoppers 4 and 5, respectively, and by the space that is available above the cutting rolls, will not be clogged, on the other hand.

The general structure of the first, i.e. of the top cutting mechanism 100 is explained first with the help of the schematic representations according to FIGS. 3, 4 and 5.

Provision is made for a framework for holding, supporting and guiding the structural components of the cutting mechanism. Said framework is comprised of the side components 101 and 102, which are connected with each other at a distance from each other by the face side components 103 and 104. The drives 10 and 11 are arranged on the face side components 103 and 104, respectively. The working rolls 120, 130, 140 and 150 are driven by said drives, with a chain drive being interconnected in each case.

Reference numeral 105 denotes the inlet opening located on top, and reference numeral 106 denotes the downwardly directed outlet opening on said cutting mechanism 100.

The drive 110 is mounted on a bearing plate 107, whereby said bearing plate 107 is pivot-mounted on a tilting bearing 108. Provision is made for this tilting bearing 108 sideways from the point of gravity of the mass of the drive 110. Above the tilting bearing 108, provision is made on the bearing plate 107 for an adjustable stop 109 that is pointing in the direction of the face side component 103 of the framework 101, and connected with said face component 103. This adjustable stop 109 is employed for the purpose of providing the driving chain with the required pretension. This driving chain is only indicated in FIG. 4 by a dashed line and connects the driving gear 110.1 of the drive 110 with the sprocket wheel of the left-hand cutting roll 120 that is mounted and driven on the pinion 112. The chain is substantially tensioned by the tilting bearing of the drive. The adjustable stop 109 is preferably serving at the same time as a damping element, so that load peaks acting on the drive can be absorbed.

The drive for the second, i.e. for the right-hand cutting roll 130 has the same type of structure as the drive described above. This drive is denoted by the reference numerals 111, 111.1, 113.

Provision is made that said first cutting mechanism 100 comprises four working rolls, namely the cutting rolls 120 and 130 and the feed rolls 140 and 150. The two cutting rolls 120 and 130 are arranged in parallel with each other below the two other working rolls, i.e. the feed rolls 140 and 150.

Each of the two cutting rolls 120 and 130, which are made of solid steel, has a multitude of the cutting disks 121 and, respectively, 131, which are mounted spaced from each other.

Viewed in the longitudinal direction, the cutting rolls 120 and 130 are arranged offset in relation to each other, so that the cutting disks 121 of the left-hand cutting roll 120 engage the gaps present between the spaced cutting disks 131 of the right-hand cutting roll 130 in a mating manner, and, vice versa, the cutting disks 131 engage the gaps between the cutting disks 121.

The feed rolls 140 and 150, which are disposed on top, are aligned in parallel with each other as well and arranged offset sideways versus the respective cutting rolls 120 and 130, respectively, in the direction of the face side components 103 and 104, respectively. The feed rolls are equipped with a great number of the feed blades 143 and 153, respectively, which in turn are spaced from each other by means of the spacer rings 144 and 154, respectively, and lined up on the respective receiving shafts 141 and, respectively, 151.

Furthermore, said feed rolls 140 and 150 are arranged in such a manner that they do not mate with the respective cutting disks 121 and 131, respectively, of the associated cutting rolls 120 and 130, respectively. However, said feed rolls reach so close to the cutting rolls 120 and 130, respectively, that when the feed blades 143 and 153, respectively, are rotating, the imaginary peripheral line of said feed blades is moving only at a small distance past the peripheral surface or jacket surface of the respective cutting disks 121 and 131, respectively.

The associated cutting roll and feed roll rotate in the same sense of rotation. What is achieved in this manner, and also by the offset, V-shaped arrangement of the working rolls in the first cutting mechanism 100, is that the materials received in the inlet opening 105 are pulled with their lower sides/surfaces in one direction by the profiled peripheral surface of the cutting disks 121 and 131, and pulled in the other direction by the feed blades 143 and 153, respectively, of the associated feed rolls 140 and 150, respectively, so that the material located directly beneath the two cutting rolls 120 and 130 is constantly kept in motion, and no upsetting bridge of accumulating material can form there.

FIG. 4 shows that provision is made in this novel cutting mechanism for a file shredder that the working rolls arranged in parallel with each other are each driven by a separate drive. For example, in the first cutting mechanism (=a 4-roll cutting mechanism) shown in FIG. 4, the left-hand cutting roll 120 is driven by the drive 110. The driving gear 110.1 of the drive 110 is connected with a driven sprocket wheel locked on the journal 112, via a chain that is indicated in said figure by a dashed line. In addition, a driving gear 112.1 is mounted on said journal 112, said driving gear engaging a driven gear 112.2 that is mounted on a journal of the receiving shaft 141 of the left-hand feed roll 140. The same applies in the same sense to the right-hand part of the cutting mechanism. Provision is made for the drive for the right-hand feed roll 150 on the side of the lateral component 102 of the framework as well. A driving gear 113.1 is arranged on the journal of the right-hand cutting roll 130, said journal projecting sideways of the lateral component. Said driving gear 113.1 engages the gear 113.2 that is secured on the receiving shaft 151 of the right-hand feed roll 150.

FIGS. 3, 4 and 5 show that in this novel cutting mechanism, a common stripper/stripping comb, i.e. the right-hand stripper 117 and the left-hand stripper 116, respectively, are associated with each of the following rolls: the right-hand lower working roll; the cutting roll 130; the right-hand upper working roll; the feed roll 150; as well as with the left-hand lower working roll; the cutting roll 120; the left-hand upper working roll; and the feed roll 140. Provision is made for recesses in each of the strippers 116 and 117, which are each associated with the core diameters 122 and 132 and preferably enclose the core diameters 122 and 132 in the form of a half-shell. The end areas of the stripping prongs of said strippers are preferably realized in the form of an acute angle. The left stripper 116 and the right stripper 117 each are supported on their lower sections 118 and 119, respectively, by a support rod 14, and are each supported on their upper sections by a support bar 15. The support rods 14 and the support bars 15 themselves are locked between and on the side parts 101 and 102 of the framework.

FIG. 6 shows the cutting mechanism 100 by a sectional side view along the section B-B according to the representation in FIG. 4. The side component 102 is visible between the face side components 103 and 104. The cutting rolls 120 and 130 are supported in said side component 102, whereby each of the bearing pins of said cutting rolls can be seen. The feed rolls 140 and 150 are supported above said pair of cutting rolls. The reference numerals 141 and 151 denote receiving shafts receiving the feed rolls 140 and 150, respectively. The drive 110 for the left-hand cutting roll 120 is indicated to the left of the side part 103.

Toward the working space, the lateral component 102 is provided with a sheet metal wear plate 16—see also FIG. 3 in this regard. Provision is made for this wear metal sheet 16 also in the lateral component 101 that is not shown in FIG. 6. The use of such sheet metal wear plates 16 on the side components permit the use of weight-reducing materials for these side components. For example, such side components 101 and 102 may be made of materials containing aluminum, which are lighter in weight but not more resistant to abrasion that the sheet metal wear plates 16. The side parts 101 and 102 do not have to be covered by the sheet metal wear plates 16 over their entire surface area; it is entirely adequate if these sheet metal wear plates 16 are provided only within the inlet area. Said sheet metal wear plates 16 may be made of one single piece for each side part, but also may be realized in the form of multi-component wear plates. A multi-component embodiment of these sheet metal wear plates 16 is shown in FIG. 6. For the sake of superior clarity, only the sheet metal wear plate arranged in the left-hand area is shown. This shown sheet metal wear plate 16 is provided in a mirrored manner also for the right-hand side of the side part 102. The figure shows that this metal sheet plate 16 reaches down to the smallest roll diameter in each case, and that it is recessed accordingly on its lower edge. This type of construction allows for material and consequently cost savings as well. In addition, a time-saving replacement of a worn wear plate 16 is assured in case any maintenance or repair is required.

FIG. 7. shows the detail “A” from FIG. 4, namely by a view from the top of a part of the right-hand side of the first cutting mechanism 100. This representation shows the engagement between the parts of the cutting rolls 120 and 130 as well as the position of the feed blades 153 of the right-hand feed roll 150, as well as the spacer rings 154 belonging to said feed roll 150, and also the associated right-hand stripper 117. Furthermore, the position of the sheet metal wear plate 16 on the side component 102 can be seen from the top. In the upper part of this representation, moreover, it is possible to see the driving gear 113.1 and the driven gear 113.2, which have already been described in detail farther above.

Furthermore, the present figure shows that the peripheral surfaces (jacket surfaces) 123 and 133 of each of the cutting disks 121 and 131, respectively, are provided with a V-shaped cut 124 and, respectively, 134.

The cutting disks 121 of the left-hand cutting roll 120 mate with the cutting disks of the right-hand cutting roll 130. The core diameters of said cutting rolls are denoted by the reference numerals 122 and 132, respectively. Other details of the construction of the cutting disks 121 and 131 are shown in the FIGS. 8a and 8b, respectively.

FIG. 8a is a side representation of the right-hand cutting roll 130 viewed in the direction from the drive 111 toward the cutting roll. On the one end of the right-hand cutting roll 130, provision is made for a profiled driving pin 113 for receiving a sprocket wheel to be driven. The opposite end of the right-hand cutting roll 130 is realized in the form of a pin 113.1, which also has a profiled jacket surface for receiving a driving gear. The area between these pins is provided with a great number of the cutting disks 131, which are spaced from one anther. Reference numeral 132 denotes in each case the core diameter of the gap formed between two neighboring cutting disks 131. As shown already earlier in the preceding FIG. 7, the peripheral surface (jacket surface) of each cutting disk 131 is provided with a V-shaped cut 134.

The technical details of each cutting disk are shown, furthermore, in FIG. 8b. This figure shows the view “X” from FIG. 8a, i.e. the cutting disk 131 is shown there by a side representation viewed from the sprocket wheel 113 (FIG. 4). The cutting teeth 136 are formed by the recesses 135 worked into the peripheral surface (jacket surface) 133; which are four recesses in the present example. In the direction opposing the direction of rotation “R” of the right-hand cutting roll 130, each tooth 136 is followed by the deepenings 137 provided in the peripheral surface (jacket surface) 133. Said recesses, however, have a substantially smaller depth than the recesses 135 forming the cutting tooth. Said deepenings 137 following each of the cutting teeth 136 effect an improved retention or gripping of the materials seized by the cutting teeth 136, or will not yet pull the materials seized by a cutting tooth 136 toward the area where the two cutting rolls 120 and 130 mate.

The cutting disks 121 of the left-hand cutting roll 120 are realized in the same manner as the cutting disks 131 described above. The reproduction of such a cutting disk 121, therefore, would be a mirrored representation of the cutting disk 131 shown in FIG. 8b.

The construction of the second cutting mechanism 200 and/or of the third cutting mechanism 300 is identical to the type of construction of the first cutting mechanism 100 previously described herein, depending on the intended case of application of the novel file shredder.

A variation of an embodiment not shown in the figures consists in that the second cutting mechanism 200 and/or the third cutting mechanism 300 are realized without the feed rolls 140 and 150. For the purpose of achieving the highest possible degree of reproducibility in the manufacture of the novel file shredder, the open recesses and breakthroughs in the side parts 101 and 102 are covered by the modified sheet metal wear plates 16, so that the so-called working space of the cutting mechanism is closed sideways (101, 102) and on the face sides (103, 104).

The novel file shredder and the novel type of construction of a cutting mechanism for such a file shredder have quasi-provided a file shredder that can be expanded modularly.

Beneath the plane E 3 on the file shredder 1, i.e. in the shown exemplified embodiment below the lower cutting mechanism, which is the cutting mechanism 300, it is possible, for example, to arrange a collection container, a conveyor belt for receiving and transporting off the crushed material, or a feed shaft for a so-called channel baling press. The employment of such an arrangement is left up to the discretion of the user of the new file shredder.

All of the features and other components of the invention mentioned in the above description, as well as also those shown only in the drawings are components of the invention as well even if they are not specially emphasized and mentioned in the claims.

### List of Reference Numerals

1 File shredder

2 Rack

2.1 Upper area

2.2 Second area

2.3 Third area

2.4 Lower area

2.5-2.10 Transverse bridges of rack

3.1 Upper guide

3.2 Second guide

3.3 Third guide

4 First hopper

5 Second hopper

6 Skids in position 3.2

7 Skids in position 3.3

8 Longitudinal bridge

9 Longitudinal bridge

10,11,12,13 Corner posts

14 Support rods

15 Support bars

16 Sheet metal wear plates

100 First cutting mechanism

200 Second cutting mechanism

300 Third cutting mechanism

101,102 Side components

103,104 Face parts

105 Upper inlet opening

106 Lower inlet opening

107 Bearing plate

108 Tilting bearing

109 Adjustable stop

110, 111 Drives

110.1, 111 Driving gears of the drives

112, 113 Driving pins (of pos. 120 and 130, resp.) with driven sprocket wheel

112.1, 113.1 Driving gears on driving pins of the cutting rolls (pos. 120 and 130, respect.)

112.2, 113.2 Driven sprocket wheels on driving pins of the receiving shafts

116 Left-hand stripper (stripping comb)

117 Right-hand stripper (stripping comb)

118, 119 Lower section of pos. 116 and 117, respec.)

120 Left-hand cutting roll

121 Cutting disk

122 Core diameter

123 Peripheral surface (jacket surface)

124 V-shaped cut

130 Right-hand cutting roll

131 Cutting disk

132 Core diameter

133 Peripheral surface (jacket surface)

134 V-shaped cut

135 Recess

136 Cutting tooth

137 Deepening (retaining groove, intake groove)

140 Left-hand feed roll

141 Receiving shaft

143 Feed blade

144 Spacer rings

150 Right-hand feed roll

151 Receiving shaft

153 Feed blade

154 Spacer rings

E1, E2, E3 Planes of pos. 3.1 to 3.3

R Direction of rotation of pos. 130

1. A file shredder comprised of a rack/frame, at least one cutting mechanism, as well as means for driving and controlling the cutting mechanism, whereby each cutting mechanism has at least two working rolls (cutting rolls), the cutting disks or cutting blades of which engage each other, with strippers being associated with the latter, characterized in that provision is made for at least two cutting mechanisms arranged one on top of the other, whereby the outlet for the cut material of the upper cutting mechanism (100) serves at the same time as the inlet for the cut material admitted into the cutting mechanism (200) arranged underneath the cutting mechanism (100).

2. The file shredder according to claim 1, characterized in that a funnel-shaped connection component in the form of a first hopper (4) is provided between the bottom edge of the housing of the upper, first cutting mechanism (100) and the top edge of the housing of the second cutting mechanism (200) arranged underneath.

3. The file shredder according to claim 1 or 2, characterized in that the upper, first cutting mechanism (100) contains four working rolls (120, 130, 140, 150) fitted with tools.

4. The file shredder according to claim 3, characterized in that each two of the four working rolls are realized identically and, furthermore, arranged in pairs and aligned parallel with each other.

5. The file shredder according to claim 4, characterized in that one pair of the working rolls is realized in the form of cutting rolls, and the other pair in the form of feed rolls (140, 150).

6. The file shredder according to claim 5, characterized in that the pair of cutting rolls is formed by a left cutting roll (120) and a right cutting roll (130), with their cutting disks (121, 131) being realized identically.

7. The file shredder according to claim 6, characterized in that at least one recess (135) is worked into the peripheral surface (132, 133) of each cutting disk (121, 131), forming at least one cutting tooth (136) in this manner.

8. The file shredder according to claim 6 or 7, characterized in that viewed against the direction of rotation®, additional recesses in the form of deepenings (137) are working into the respective peripheral surfaces (123 and 133, respectively, following each cutting tooth (136), whereby such deepenings (137) have a substantially lower depth than the recess (135).

9. The file shredder according to claim 6, 7 or 8, characterized in that the peripheral surfaces (123 and 133) of each cutting disk (121 and 131, respectively), and of the right-hand cutting roll (130) have the shape of an inward “V” (124; 134).

10. The file shredder according to at least one of claims 3 to 9, characterized in that a stripper/stripping comb (116) is commonly associated with the left-hand cutting roll (120) and the left-hand feed roll (140), and a stripper/stripping comb is commonly associated with the right-hand cutting roll (130) and the right-hand feed roll 150).

11. The file shredder according to claim 10, characterized in that the left-hand stripper (116) and the right-hand stripper (117) each comprise two recesses, whereby in each case, one of said recesses rests against the core diameter (122, 132) of the respective cutting roll (120, 130), and against the core diameter of the receiving shaft (141, 151) of the left-hand feed roll (140) and, respectively, against the right-hand feed roll (150), preferably in the form of a half-shell.

12. The file shredder according to claim 10 or 11, characterized in that the left-hand stripper/stripping comb with its lower sections (118), and the right-hand stripper/stripping comb (117) with its lower sections (119) each are secured and supported between the side components (101, 102); and that the upper areas of the left-hand stripper/stripping comb (116) and of the right-hand stripper/stripping comb (117) are retained on support bars, with the latter being fastened between the side components (101, 102) as well.

13. The file shredder according to at least one of the preceding claims, characterized in that a metal sheet wear plate (16) is arranged on the surface of each of the side components (101, 102), said surfaces being directed inwards toward the working rolls.

14. The file shredder according to claim 13, characterized in that the sheet metal wear plates (16) is realized in the form of one single piece.

15. The file shredder according to claim 13, characterized in that the sheet metal wear plates (16) are realized in the form of multi-component plates.

16. The file shredder according to claim 13, 14 or 15, characterized in that the sheet metal wear plates (16) cover the inner surface of the side components (101, 102) by sections.

17. The file shredder according to claim 1 or 2, characterized in that the top, i.e. the first cutting mechanism is realized according to at least one of claims 3 to 16; and that the other cutting mechanisms (200 and/or 300) arranged underneath the cutting mechanism (100) only comprise a pair of working roll, i.e. the left-hand cutting roll (120) and the right-hand cutting roll (130), said cutting rolls each having strippers associated with them.

18. The file shredder according to claim 17, characterized in that the provided strippers are realized in the form of at least one of claims 10 to 12.
